(19) United States
(12) Patent Application Publication
(10) Pub. No.: US 2002/0161924 A1
(43) Pub. Date: Oct. 31, 2002

(54) Method and apparatus for routing data over a computer network

(76) Inventors: Robert E. Perrin, Sacramento, CA (US); Keith A. Hoek SR., Wheatland, CA (US)

Correspondence Address: DKW LAW GROUP, P.C., 58TH FLOOR - USX TOWER, 600 GRANT STREET, PITTSBURGH, PA, 15219, US

(21) Appl. No.: 09/845,847

(22) Filed: Apr. 30, 2001

(51) Int. Cl. G06F 15/173

(52) U.S. Cl. 709/240

(57) ABSTRACT

The present invention relates to a method and apparatus for routing data, and more particularly to a novel backplane for use in a data routing device, said backplane being a passive backplane. The present invention is also directed to a data routing device employing such a novel passive backplane.

### FIELD OF THE INVENTION

The present invention relates to a method and apparatus for routing data, and more particularly to a novel backplane for use in a data routing device, said backplane being a passive backplane. The present invention is also directed to a data routing device employing such a novel passive backplane.

### BACKGROUND OF THE INVENTION

Networked computers have become a mainstay in all facets of life. One important benefit of most networked computer systems is the ability to easily and quickly share information/data between networked computers.

The networks providing data communication between computers can be local in nature linking a relatively few concentrated computers via a local area network (“LAN”), or over a relatively wider area via a wide area network (“WAN”), or range from inter-connecting any or all of individual computers, LANs and/or WANs via a global computer network, as for example the Internet and its World Wide Web (“WEB”) subcomponent to interconnect computers the world over. Unless otherwise clear from the context of use, the term “network” hereinafter shall include LANs, WANs, global networks and/or any other networking of computers to provide data communication there between.

Much advancement has been made in the relatively recent past in the infrastructure linking such computers via a network. This includes advancements in both software and hardware necessary for the operation of such networks.

The term “hardware” includes cabling, jacks and other devices necessary to make the physical connection between the computers or other devices on the network to enable data to flow over the network. The term “hardware” also includes computer cards, computer boards and other devices that may/must be inserted into a computer that is to be linked over the network to permit that computer to share information over the network. The term “hardware” also includes devices that are separate and apart from the computers that are to be linked over the network, which devices are placed within the computer network and become a part of the network's infrastructure and operate to perform some function necessary for the operation of the network. Devices in this last category of hardware include routers, and bridges, for example.

More particularly, it is most common in the presently available networking systems for large concentrations of data that is to be transferred from a first computer to a second computer on the network to be packetized. In this process the large data file that is to be transferred is broken into smaller subcomponents or “data packets” and the data packets are provided with address information that indicates where that packet destination (the second computer) may be found on the network. The data packets are then sent over the network via a variety of paths, and devices on the network forward any given data packet in the direction of its intended destination using the address information described above. The data packets are forwarded in any order until they arrive at the desired destination, whereupon the packets are reassembled at the destination (e.g. the second computer) to recreate the transferred data on the second computer. As may be appreciated, at any one time there are millions of packets flowing over a computer network of any size, and devices such as routers operate as junction points between the many paths of the network receiving the data packets and forwarding them along the appropriate path of the network toward the data packet's intended destination.

It is a difficult enough task to complete this operation and to transfer the data packets with sufficient speed and accuracy as to render the network useful without malicious intervention, but the matter is further complicated when intentionally or inadvertently an entity floods the network with data packets that overload or otherwise damage the ability of the network to route the data packets over the network. Intentional attacks are sometimes referred to as denial of service (“DoS”) attacks and if successful render the attacked computer, network or other device temporarily or permanently unable to effectively transfer data over the computer network. Particularly troublesome are intentional attempts by computer hackers to interrupt or otherwise destroy data flow. Therefore, there have been both hardware and software developments, but particularly software developments, that attempt to thwart such attacks, and such software may reside on the interconnected computers, on the infrastructure devices such as the router described above, or both. These systems to prevent DoS attacks are sometimes referred to as a “firewall” in the sense that as a firewall in a building or other structure operates to protect to provide protection from a fire on one side of the wall for occupants or equipment on the other, these systems operate to protect the computer or other device from attacks coming from the computer network. As may be appreciated, however, the term “firewall” is generally not limited to DoS attack protection alone, and firewalls typically provide other protections such as protection from computer viruses and/or privacy/access restrictions/protections, among others. Thus for example, a routing device may include several junctions (referred to as “ports”) with the computer network for receiving and forwarding data packets and a means within the router for reading the address information and selecting the proper path along which to forward the data packet, and the router may further be equipped with firewall protection to prevent, for example, DoS attacks on the router itself or the computer network as a whole.

A router generally includes at least the following components, not in any particular order. First, it is generally housed within a box-like housing. Second, there is typically a power supply to enable the unit to function, which is typically powered by plugging the unit into an AC current, 120 volt power source and, third, an on/off switch to turn the unit off and on. Fourth, the router usually includes a plurality of ports, also known as interfaces, for example between three and twelve in number, which are visible and accessible from the exterior surface of the device, which physically resemble telephone jacks to enable the unit to be connected via cabling to several computers or devices on the network. The ports are often named in terms of the amount of data they can carry. For example, 10/100 megabit (“Mb”) ports can carry zero to 100 megabits per second of data. One gigabyte ports can carry 125,000,000 bytes of data per second. Routers may include a mixture of such ports, wherein some may for example be 10/100 Mb ports whereas others are one gigabyte ports all in the same router. As may be appreciated, the rate of data transfer is not a factor of the port alone, but rather it is the supporting circuitry described below that enables a named port to operate at or about its named speed.

The ports themselves typically reside on a fifth component, an electronic circuit board or card. The port-bearing electronic circuit board is often referred to as a network interface card (“NIC”).

Any number of ports may be associated with a NIC, but often there are four ports affixed to each NIC. A router having 12 ports would then, for this example, include three NICs.

The three port-bearing NICs are plugged into a sixth component, a common electronic circuit board or card, known as a backplane, each NIC being inserted into its own respective plug, slot or socket on the backplane. A backplane operates much like an electrical junction box, and, more particularly, is an electronic circuit board containing circuitry and sockets into which additional electronic devices on other circuit boards or cards can be plugged. The backplane in this example operates to provide data communication pathways between the 12 ports on the three port-bearing NICs.

A backplane typically operates only as an intermediary board to provide pathways between the various ports, and the backplane is typically itself placed in data communication, via another plug, slot or socket on the backplane with a seventh component, which is another electronic circuit board, which other electronic circuit board in fact reads the address information and operates as the “brain” for the device, deciding which pathway the received data packet should be forwarded along. The decision-making electronic circuit board is referred to as a single board computer (“SBC”).

Finally, typical router includes as an eighth component a plurality of fans to keep the temperature in the unit fairly constant and to avoid damage to the components from heat.

The SBC may or may not have an operating system associated with it. The router may also include additional components to permit an administrator of the router to configure certain operational or other parameters of the router and/or the SBC. As used herein a “user” generally refers to any entity utilizing the router, but the term “administrator” is generally reserved for an entity having permissions to configure the router. The additional components may include interfaces for keyboards and monitors and serial or other ports to permit data communication with a terminal or other device to permit configuration of the router and/or the SBC. The router and/or the SBC may be configured by directly plugging in a keyboard and/or terminal, or, particularly where the SBC has its own operating system, it may be configured remotely by a user over the network via the existing ports or additional ports or interfaces added for that express purpose.

Backplane systems do not have a motherboard in the true sense of the word. In a backplane system, the components normally found on a motherboard are located on the SBC.

Backplane systems come in two main types: passive and active.

A passive backplane means the main backplane board does not contain any bus control circuitry except for the bus connectors. All the circuitry found on a conventional motherboard is contained on one or more expansion cards installed in slots on the backplane. Some backplane systems incorporate the entire system circuitry into a single mothercard (e.g. the SBC). The mothercard is essentially a complete motherboard that is designed to plug into a slot in the passive backplane. The passive backplane/mothercard concept allows the entire system to be easily upgraded by changing one or more cards.

An active backplane means the main backplane board contains bus control circuitry and usually other circuitry as well. In essence, such backplanes include an additional integrated circuit chip which operates like a repeater/buffer/driver to facilitate movement of the data packets over the various circuit pathways on the backplane. While this chip facilitates data packet movement, it also forms a system bottleneck on the backplane as all data must pass over the chip which creates an inherent time delay, and adds additional cost to the manufacture of the backplane as the chip itself is expensive and its placement on the backplane can require expensive and specialized equipment and skills. Also, while most active backplane systems contain some of the circuitry found on a typical motherboard, such active backplanes generally still do not include a processor complex, which remains present on the SBC.

Keeping the SBC on its own circuit board as opposed to placing the processor complex on the active backplane allows the user to easily upgrade to a new processor type by changing only the SBC card. In effect, it amounts to a modular motherboard with a replaceable processor section. In devices other than routers, as for example, most modem personal computer (“PC”) systems that use a backplane design use an active backplane/processor complex. Both IBM and Compaq have used this type of design in some of their high-end (server class) systems, for example. The theoretical advantage of a backplane system, however, is that you can upgrade it easily to a new processor and new level of performance by changing a single card (e.g. the SBC card). If the processor complex were built into the backplane board to form a type of motherboard-design system, upgrading the processor would require changing the entire processor complex/backplane combination, a seemingly more formidable task. However, development of the upgradeable processor (e.g. Intel has designed all 486, Pentium, Pentium Pro, and Pentium II processors to be upgradeable to faster (sometimes called OverDrive) processors in the future by simply swapping (or adding) the new processor chip) has created the possibility of changing only the processor chip for a faster one, which may be the easiest and generally most cost-effective way to upgrade without changing the entire processor complex/backplane combination.

Generally, the presently available active or passive backplane boards do not have a power supply regulator formed within or on such backplane boards but must obtain power via complex cabling from the power supply located elsewhere in the router housing and not otherwise associated with the backplane board.

Whether active or passive, for all routers, and indeed for all computer network hardware and even arguably for all computer equipment, there is ever-felt marketplace pressure and there remains a need in the art to design and build a router in such a way that it is easier to manufacture, less expensive to manufacture, faster to manufacture, smaller in overall dimensional size which can more quickly and accurately process data, preferably with new and additional functionality (e.g. firewall protection, etc) over known router designs.

### SUMMARY OF THE INVENTION

The present invention is directed to an improved design for a backplane board for use in a computer networking router comprising:

a backplane board substrate having a plurality of electrical circuitry pathways over said backplane board;

a plurality of electronic circuit board expansion slots located on said substrate and in data communication with said electrical pathways, each slot adapted to receive a network interface card and retain said network interface card spaced apart from but in a generally parallel plane with said backplane board substrate; and

at least one electronic circuit board expansion slot adapted to received a single board computer; wherein said backplane board is a passive backplane board and said router case is one rack unit in height.

In alternative embodiments the novel backplane board of the present invention is provided with several additional components including but not limited to an electrically erasable programmable read only memory chip (also known as an “EEPROM” or an “E²-PROM” which is in data communication with the SBC which can be programmed for a variety of functions including to provide a hardware serial number, to control startup and/or operation of the router, as for example requiring a data key to be transmitted from the memory chip to the SBC before the router will operate. The E²-PROM transmits data to the SBC in response to a request from the SBC.

The novel backplane board may also be provided with a plurality of diagnostic light emitting diodes (LEDs) which will indicate the status of the operation of the backplane board.

Also preferably, the backplane board includes a half-wave bridge rectifier providing the ability for the dual power supplies to both power the backplane board and provide fail over protection should either power supply fail.

The present invention is also directed to a novel router employing the novel passive backplane board of the present invention. The novel router of the present invention includes a housing having retained therein the following components: a pair of redundant power supplies, an on/off switch for operation of the device, a plurality of cooling fans retained within said housing, a plurality of ports accessible externally of said housing, said ports being provided on and in data communication with at least one NIC, an SBC, a backplane board substrate having a plurality of electrical circuitry pathways over said backplane board, a plurality of NIC-receiving electronic circuit board expansion slots located on said backplane board substrate and in data communication with said electrical pathways, said NIC being retained within and in data communication with at least one slot adapted to receive said NIC and retain said NIC spaced apart from but in a generally parallel plane with said backplane board substrate, an SBC-receiving electronic circuit board expansion slot, said SBC being retained within and in data communication with said electrical pathways in said backplane board substrate, a half wave bridge rectifier on or within said backplane board substrate which half wave bridge rectifier is adapted to receive electrical current from said power supplies and to distribute said electrical current to one or more components affixed to said backplane board substrate.

Preferably, the novel router's redundant power supplies include takeoffs from the backplane board to power the fans, wherein the takeoffs to the fans include a polyfuse (a type of self resetting fuse). This arrangement permits each fan to operate regardless of a failure in the electrical circuitry of other the fans.

In alternative embodiments the backplane board of the novel router of the present invention is provided with several additional components including but not limited to a programmable memory chip which is in data communication with the SBC which can be programmed to control startup and/or operation of the router, as for example requiring a data key to be transmitted from the memory chip to the SBC before the router will operate.

The novel backplane board of the novel router of the present invention may also be provided with a plurality of diagnostic light emitting diodes (LEDs) which will indicate the status of the operation of the backplane board.

The SBC of the novel router of the present invention may or may not have an operating system associated with it. The router may also include additional components to permit a user of the router to configure certain operational or other parameters of the router and/or the SBC. Such components may include interfaces for keyboards and monitors and serial or other ports to permit data communication with a terminal or other device to permit configuration of the router and/or the SBC. The router and/or the SBC may be configured by directly plugging into the router a keyboard and/or terminal, or, particularly where the SBC has its own operating system, it may be configured remotely by a user over the network via the existing ports or additional ports or interfaces added for that express purpose.

The novel backplane of the present invention provides several advantages over known active backplane boards. It operates up to 10% faster than known active backplane boards. It is only one rack unit high taking up far less space than known router systems while providing far greater port density in that one rack unit high silhouette. By avoiding the need for an active backplane, the electrical circuitry is much simpler, easier and less costly to imprint in the backplane board substrate. It is easier to manufacture the finished backplane, as less sophisticated technology can be employed for assembly. Further, providing power directly from redundant power supplies to a half wave bridge rectifier associated with the backplane board substantially reduces the wiring harness necessary to operate the backplane board, resulting in less cost and greater ease of manufacture. Providing the E²PROM on the backplane board provides limited non-volatile data storage that is more secure and tamper resistant than that provided on the SBC or attached mass storage devices such as hard drives or solid state disks. Providing the diagnostic LEDs on the backplane board permits much easier diagnosis of the operation, and in particular, for example, of the power supply operation on the backplane board. The novel router of the present invention also provides the advantage that the sequential numbering of the ports when a plurality of ports is present proceeds from one end of the aligned ports to the other, such that port 1 is logically the first and left-most port proceeding in increasing numerical sequence to port 12 at the right-most portion of the aligned ports. Known routers do not have this capability and it is not at all intuitive where port 1 is located along the aligned string of ports. Further, unlike known router systems employing an active backplane, it is not necessary to populate each and every NIC-receiving electronic circuit board expansion slot located on said backplane board substrate for the backplane board to operate, in contrast to known routers require that each and every NIC-receiving electronic circuit board expansion slot located on said backplane board substrate to be populated by a NIC for the backplane board to operate.

The router of the present invention can operate with a PCI bus with 32-bits and 33 megahertz clock speeds without the need for an active backplane board at speeds up to 10% faster than presently available 32-bit/33 megahertz router systems.

In a preferred embodiment, the router of the present invention is also equipped with adaptive firewall protection, and in particular with DoS protection. It can support up to twelve 10/100 Mb ports or eight 10/100 Mb ports and one gigabit port.

### BRIEF DESCRIPTION OF THE DRAWINGS

FIG. 1 front perspective view of the novel router of the present invention.

FIG. 2 is a back perspective view of the novel router of the present invention.

FIG. 3 is a front perspective view of the components of the novel router of the present invention.

FIG. 4 is a top plan view of a prior art active backplane board.

FIG. 5 is a top plan view of the novel passive backplane board of the present invention.

### DETAILED DESCRIPTION OF THE PREFERRED EMBODIMENTS

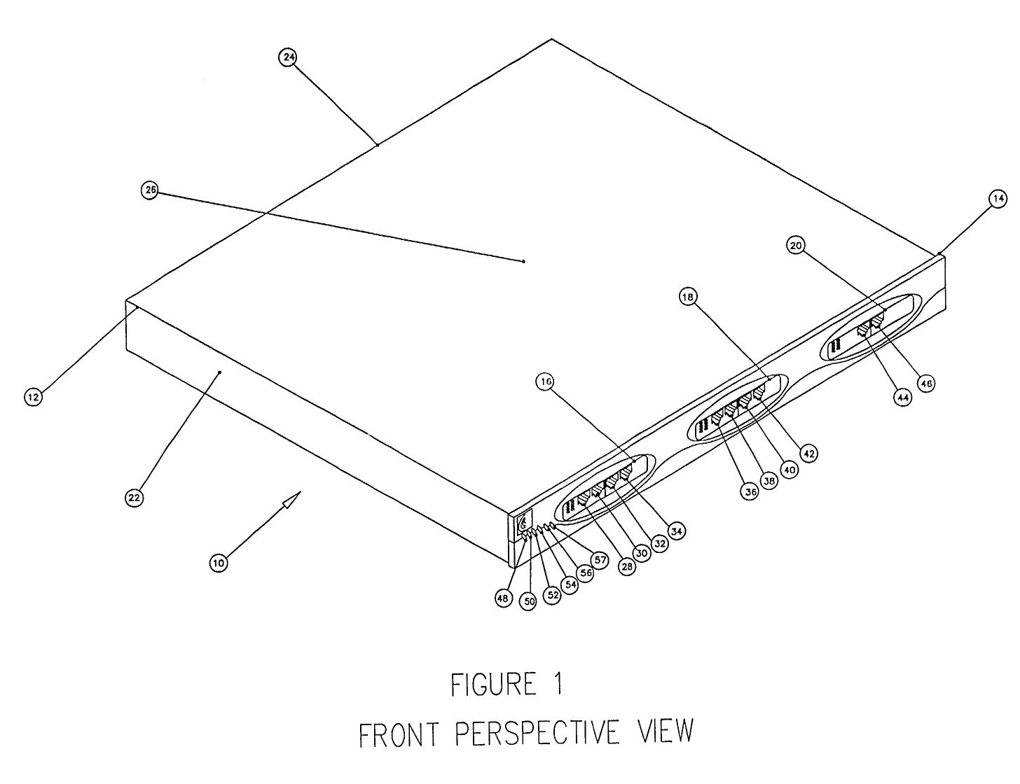

Illustrated in FIG. 1 is a front perspective view of the novel router 10 of the present invention. The novel router 10 includes chassis 12 in which the components described below are retained. The chassis includes front wall 14 having openings 16, 18 and 20 there through, side walls 22 and rear wall 24. The chassis 12 is enclosed within cover 26, which cover 26 is affixed to the chassis 12 by any means known in the art, typically with a plurality of screws, not shown.

The openings 16, 18 and 20 are adapted to receive there through ports 28-46. The precise number of ports is not limiting to the present invention, and more or less ports may be employed within the scope of the present invention. Also, the capacity of the ports may be the same or may be different. For example, ports 28-42 in the example illustrated are 10/100 Mb ports, and ports 44,46 collectively are a one gigabyte port respectively. But this example is non-limiting, the present invention may include any combination of ports in any data carrying capacity. The ports operate as interfaces to permit cabling to be inserted into the ports to provide data communication between the router 10 and other devices, such as computers to be networked via the router 10 or other devices such as, but not limited to other routers. In fact, any PCI based network interface card may be used in the ports, e.g. cards to interface to T-1, OC-*, token ring, ARCNET, V0.35, FDDI, ATM, DSL, ISDN, or other devices, which allows the backplane to be adaptable to a variety of networking environments.

Also illustrated in FIG. 1 are a plurality of LEDs 48-57 which operate to provide the user of the router 10 with certain information regarding the operation and performance of the router 10. The precise number of LEDs and their placement on the router 10 are not limiting to the present invention, and more or less LEDs or other optical and/or audible devices may be employed to provide the user with more or less operational or performance feedback. However, in this embodiment the six LEDs 48-57 do perform certain useful functions.

In normal operation, the LEDs provide a visual indication of network activity through the router. The LEDs provide a bar graph display where more energized LEDs indicate more network traffic through the router. When two routers are paired together to form a high-availability router, one LED acts as a “heart-beat” to provide a visual indication that each router is communicating with the other. The remaining five LEDs continue to act as a bar graph of network traffic.

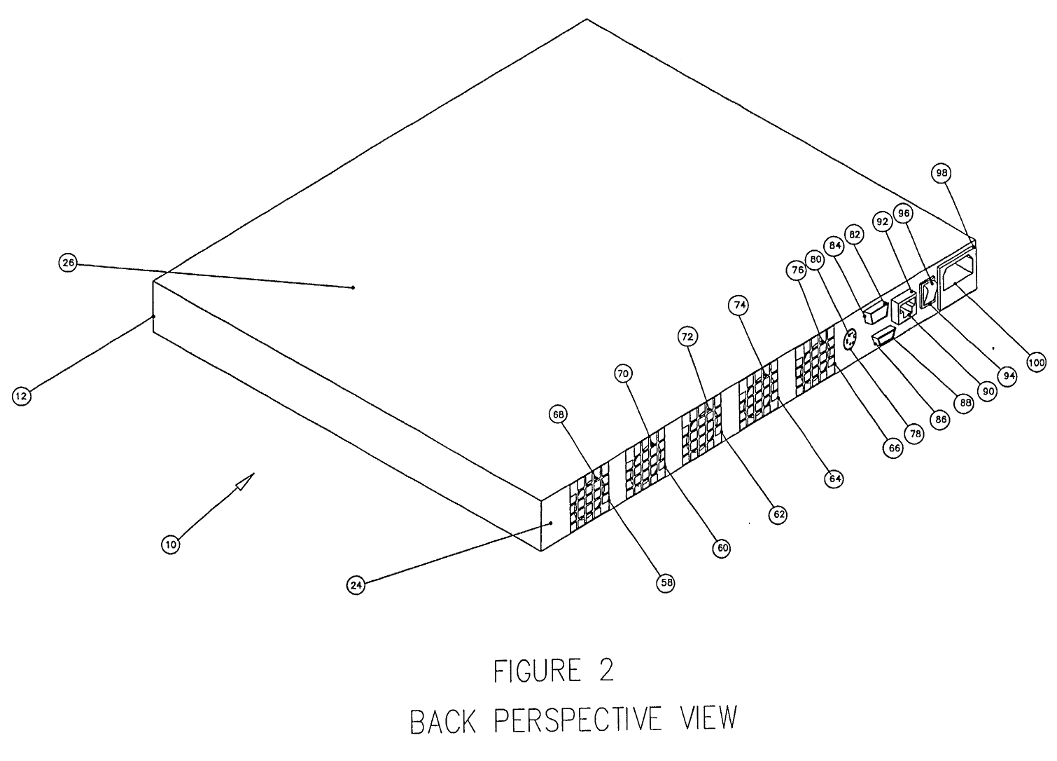

Referring now to FIG. 2 there is illustrated a rear perspective view of the router 10. As illustrated in FIG. 2, the cover 26 is in place over the chassis 12. The rear wall 24 contains a plurality of openings therein to accommodate certain purposes. The precise number of openings and their placement are not limiting to the present invention and more or less openings may be employed as within the scope of the present invention. However, as illustrated in FIG. 2 there are a plurality of openings 58-66 to accommodate air flow past a plurality of cooling fans 68-76.

In the embodiment illustrated in FIG. 2 an opening 78 is provided to accommodate a circular pin connector 80 which may be used, for example, to permit a keyboard or other device to interface with the router 10 for example, for the purpose of configuring the router 10. An opening 82 is provided to accommodate a D-SUB connector 84 which may be used to interface a terminal with the router 10 for example, for the purpose of configuring the router 10. An opening 86 may be provided to accommodate a D-SUB connector 88 to permit a monitor or other display device to be interfaced with the router 10, also for example, for the purpose of configuring the router 10. An opening 90 may be provided to accommodate a RJ-45 connector 92 which may be used to interface a computer network with the router 10. For example, for the purpose of configuring ther router 10, as some network installations use dedicated, private computer networks solely to configure and monitor their networking equipment. An opening 94 may be provided to permit an on/off switch 96 to be provided to operate the router 10. Finally, an opening 98 may be provided to accommodate a power cord interface 100 for the purpose of supplying electrical power to the router 10. However, as stated above and as repeated here, the exact number of openings, their placement and their purposes are not limited to those illustrated in FIG. 2, and more or less openings may be provided for more or less purposes.

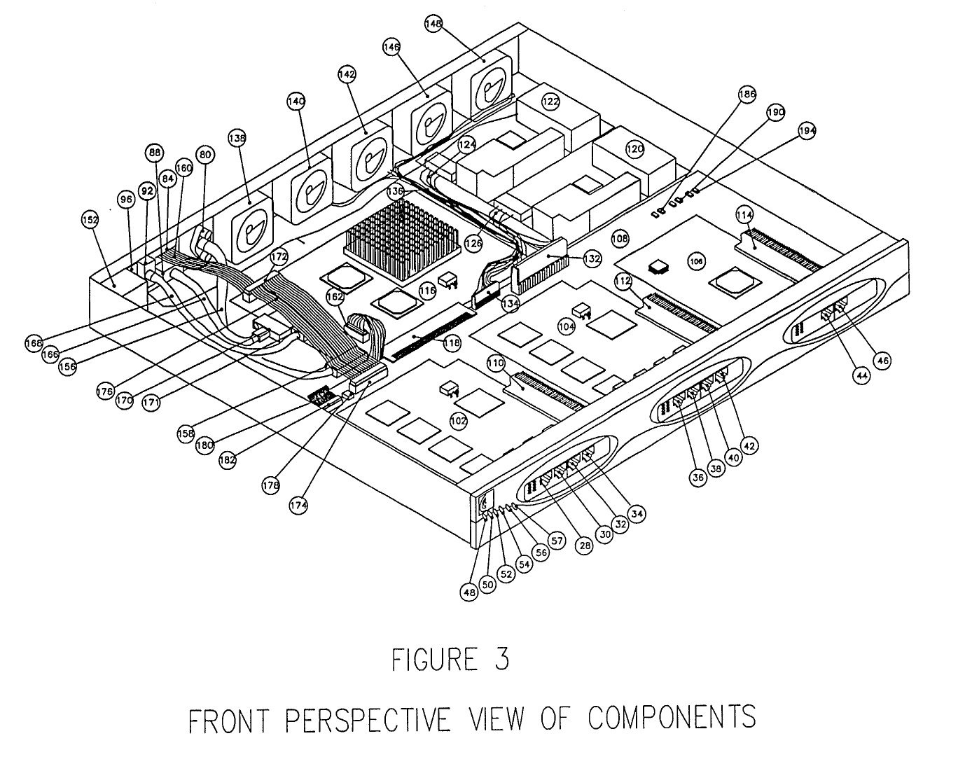

Referring now to FIG. 3, there is illustrated a front perspective schematic view of the router 10 with the cover 26 off, illustrating the major components of the router 10. The ports 28-34 reside on and are in data communication with network interface card (“NIC”) 102. The ports 36-42 reside on and are in data communication with NIC 104. The ports 44 and 46 reside on and are in data communication with NIC 106.

NICs 102-106 reside on and are in data communication with backplane board 108. More particularly, NIC 102 is supported on and provides its data communication with backplane board 108 via peripheral component interface (“PCI”) connector 110. NIC 104 is supported on and provides its data communication with backplane board 108 via PCI connector 112. Finally, NIC 106 is supported on and provides its data communication with backplane board 108 via PCI connector 114.

Data entering any of the ports 28-46 is then in communication over the respective NIC to the backplane board 108. Backplane board 108 is then in data communication with single board computer (“SBC”) 116 via PCI Industrial Computer Manufacturing Group (“PIC MG”) connector 118.

Power is supplied to the backplane board 108 from redundant power supplies 120 and 122. The electrical current carried by the wiring harnesses 124 and 126 is provided to the backplane board 108 via electrical power junction block 132.

Electrical power is transferred from the electrical power junction block 132 to a second electrical power junction block 134 where the power is transferred via wiring harness 136 to fans 138 through 148. The electrical line to each fan 138-148 in the wiring harness 136 or on the backplane board 108, includes a polyfuse (a type of self resetting fuse). This arrangement permits each fan to operate regardless of a failure in any other fan. Also illustrated in FIG. 3 is the electrical power interface 152 and the wiring harness to provide electrical power to the power supplies 120 and 122.

The back side of power switch 96 is illustrated in FIG. 3. Also illustrated in FIG. 3 is the back side of connector 80 which may be used, for example, to permit a keyboard or other device to interface with the router 10 via cable 156 to junction 158 on SBC 116.

The back side of D-SUB connector 84 is illustrated in FIG. 3. Connector 84 is in communication with SBC 116 via cable 160 and junction 162.

The back side of D-SUB connector 88 which functions to permit a monitor or other display device to be interfaced with the router 10 is illustrated in FIG. 3. It too is in communication with SBC 116 via cable 166 to junction 170.

The back side of RJ-45 connector 92 is illustrated in FIG. 3 which is in turn in communication with SBC 116 via cable 168 and junction block 171.

Extending between junction block 172 on SBC 116 to junction block 174 on backplane board 108 is cable 176, which provides data communication from the SBC 116 to the E2PROM 178 on back plane board 108.

The six LED's 48-57 on the front of the router 10 are provided with an electrical signal to activate the LEDs 48-57 via cable 180 which is connected viajunction block 182 to backplane board 108. LEDs 186, 190 and 194 are also present on the backplane board 108 to provide system monitoring and diagnosis, as for example whether the LEDs may be used to indicate the status of the system power supplies. LEDs 186,190

During normal operation, the six LEDs 48-57 provide a bar graph of the real-time network utilization where more traffic is indicated by more LEDs being lit. During operation in a high availability (“HA”) mode, five of the LEDs display network utilization rate and one LED displays HA heartbeats, preferably at the rate of about one blink per second. LED use is preferably controlled by software, thus new LED display modes may be added as desired. During testing, the LEDs are cycled on and off repeatedly to test the operation of the SBC circuitry as well as the LEDs themselves and associated hardware and cabling, LEDs 186, 190 and 194 may be configured to provide a visual indication of the status of the redundant power supplies. This feature is useful, for example, during manufacturing to check the operation of the power supplies, as well as during troubleshooting of the device in the field.

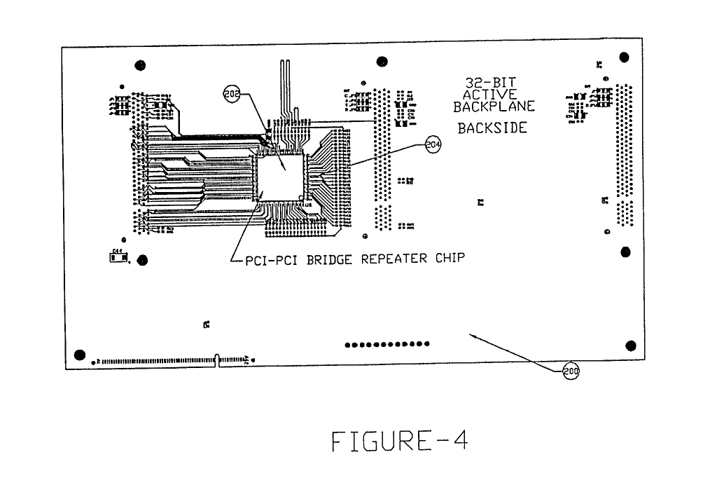

Referring now to FIG. 4 there is illustrated a bottom plan view of a prior art active backplane board 200. The active backplane board 200 includes a bridge repeater chip 202 and exceedingly complex circuitry 204 to establish the necessary electrical pathways to enable the active backplane board 200 to operate.

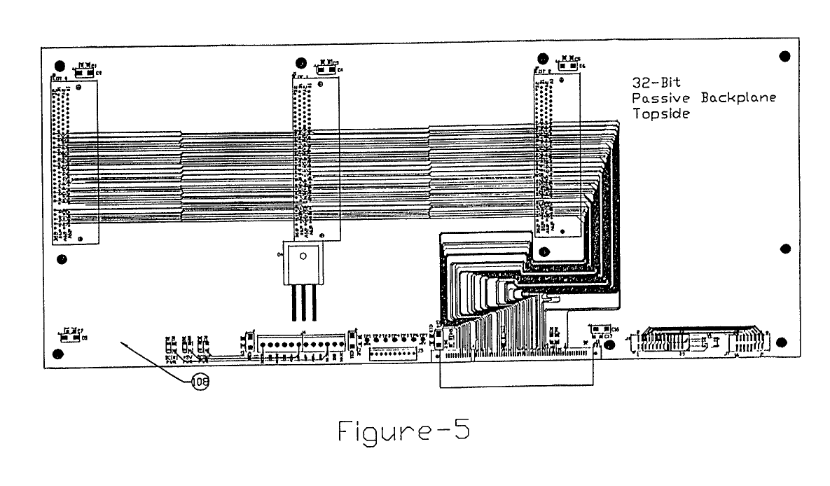

Referring now to FIG. 5 there is illustrated a top plan view of the passive backplane board 108 of the present invention. In addition to the absence of any repeater chip, the electrical pathways necessary to establish the necessary degree of interconnection of the various components of the novel router of the present invention are clearly much more simple than those of known active backplane board 200.

As noted above, the novel backplane of the present invention provides several advantages over known active backplane boards. It operates up to 10% faster than known active backplane boards. It is only one rack unit high taking up far less space than known router systems while providing far greater port density in that one rack unit high silhouette. By avoiding the need for an active backplane, the electrical circuitry is much simpler, easier and less costly to imprint in the backplane board substrate. Providing power directly from redundant power supplies to a half wave bridge rectifier associated with the backplane board substantially reduces the wiring harness necessary to operate the backplane board, resulting in far less cost and greater ease of manufacture. Providing the E²PROM on the backplane board provides the advantage of a software readable serial number for the backplane itself. This allows the router software or other administrative software to verify that it has access to a bonafide backplane prior to operation. Providing the diagnostic LEDs on the backplane board permits much easier diagnosis of the operation, and in particular the power supply operation on the backplane board. The novel router of the present invention also provides the advantage that the sequential numbering of the ports when a plurality of ports is present proceeds from one end of the aligned ports to the other, such that port 1 is logically the first and left-most port proceeding in increasing numerical sequence to port 12 at the right-most portion of the aligned ports. Known routers do not have this capability and it is not at all intuitive where port 1 is located along the aligned string of ports. Further, unlike known router systems employing an active backplane, it is not necessary to populate each and every NIC-receiving electronic circuit board expansion slot located on said backplane board substrate for the backplane board to operate, in contrast to known routers require that each and every NIC-receiving electronic circuit board expansion slot located on said backplane board substrate to be populated by a NIC for the backplane board to operate.

The router of the present invention can operate with a PCI bus with 32-bits and 33 megahertz clock speeds without the need for an active backplane board at speeds up to 10% faster than presently available 32 bit/33 megahertz router systems.

The present invention has been described in connection with certain embodiments. However the present invention is not intended to be so limited and other embodiments are contemplated as within the scope of the present invention as described in the foregoing and in the following claims.

We claim:

1. A backplane board for use in a computer networking router comprising:
a. a backplane board substrate having a plurality of electrical circuitry pathways;
b. a plurality of electronic circuit board expansion slots located on said substrate and in data communication with said electrical pathways, each slot adapted to receive a network interface card and retain said network interface card spaced apart from but in a generally parallel plane with said backplane board substrate; and
c. at least one electronic circuit board expansion slot adapted to receive a single board computer;
wherein said backplane board is a passive backplane board.

2. The backplane board of claim 1 wherein said backplane board further comprises an E²PROM memory chip.

3. The backplane board of claim 1 wherein said E²PROM memory chip is in data communication with a single board computer, said E²PROM memory chip further comprising a means for providing an identifying item to said single board computer, whereupon said single board computer upon receiving said identifying item permits a router employing said backplane board and said single board computer to operate.

4. The backplane board of claim 3 wherein said identifying item is selected from the group consisting of a hardware serial number associated with said backplane board, a data key, and combinations thereof.

5. The backplane board of claim 1 wherein said backplane board further comprises a plurality of light emitting diodes.

6. The backplane board of claim 5 wherein said light emitting diodes are adapted to provide functions selected from the group consisting of providing a visual indication of the real time network utilization rate of said backplane board, providing a visual indication of the operation of the backplane board for the diagnosis of the operational state of said backplane board, and combinations thereof.

7. The backplane board of claim 6 wherein during operation in a high availability mode, at least a portion of said light emitting diodes display said network utilization rate, and a portion of said light emitting diodes displays high availability heartbeats in blinks per unit of time.

8. The backplane board of claim 2 whrein said backplane board further comprises a plurality of light emitting diodes.

9. The backplane board of claim 8 wherein said light emitting diodes are adapted to provide functions selected from the group consisting of providing a visual indication of the real time network utilization rate of said backplane board, providing a visual indication of the operation of the backplane board for the diagnosis of the operational state of said backplane board, and combinations thereof.

10. The backplane board of claim 9 wherein during operation in a high availability mode, at least a portion of said light emitting diodes display said network utilization rate, and a portion of said light emitting diodes displays high availability heartbeats in blinks per unit of time.

11. The backplane board of claim 1 wherein said backplane board includes three electronic circuit board expansion slots located on said backplane board substrate and in data communication with said electrical pathways, easch electronic circuit board slot being adapted to receive a network interface card and retain said network interface card spaced apart from but in a generally parallel plane with said backplane board substrate.

12. The backplane board of claim 1 wherein said backplane board is adapted to operate in a router, wherein said router is approximately one rack unit in height.

13. The backplane board of claim 1 wherein said backplane board is adapted to operate in a router, wherein said router is one rack unit in height.

14. The backplane board of claim 1 further comprising a half-wave bridge rectifier.

15. The backplane board of claim 14 wherein said backplane board is adapted to receive electrical power from at least two power supplies and said half-wave bridge rectifier operates to provide fail over protection to permit said backplane board to continue to operate from electrical power supplied by only one of said power supplies should either power supply fail to provide electrical power to said backplane board.

16. A router comprising:
a. a housing;
b. a plurality of data communication ports accessible externally of said housing, said ports residing on and in data communication with a network interface card;
c. a single board computer; and
d. a passive backplane board interposed between said network interface card and said single board computer, said backplane board providing data communication between said network interface card and said single board computer, said backplane board comprising a backplane board substrate having a plurality of electrical circutry pathways, a network interface card-receiving electronic circuit board expansion slot located on said backplane board substrate for receiving said network interface card and in data communication with said electrical pathways, and a means for providing data communication between said backplane board and said single board computer;
wherein said network interface card is retained within said network interface card-receiving electronic circuit board expansion slot in a spaced apart but generally parallel plane with said backplane board substrate and wherein said router housing is approximately one rack unit in height.

17. The router of claim 16 wherein said backplane board comprises a plurality of network interface card-receiving electronic circuit board expansion slots.

18. The router of claim 17 wherein a portion of said plurality of electronic circuit board expansion slots are populated with a network interface card and a portion of the electronic circuit board expansion slots are not populated with a network interface card.

19. The router of claim 17 wherein the backplane board comprises three network interface card-receiving electronic circuit board expansion slots.

20. The router of claim 19 wherein the group of electronic circuit board expansion slots populated with a network interface card are selected from the group consisting of one, two and three of said electronic circuit board expansion slots.

21. The router of claim 20 wherein said data communication ports are selected from the group consisting of 10/100 megabit ports, one gigabyte ports and combinations thereof.

22. The router of claim 21 wherein each of said network interface cards includes four data communications ports, and each of said data communications ports are 10/100 megabit ports.

23. The router of claims 16, 17, 21 or 22 wherein said means for providing data communication between said backplane board and said single board computer is selected from the group consisting of an electronic circuit board expansion slot located on an in data communication with said backplane board, said expansion slot being adapted to receive said single board computer and a PCI Industrial Computer Manufacturing Group PIC MG connector.

24. The router of claim 23, wherein said backplane board further comprises an E²PROM memory chip.

25. The router of claim 25 wherein said E²PROM memory chip is in data communication with said single board computer, said E²PROM memory chip further comprising a means for providing an identifying item to said single board computer, whereupon said single board computer upon receiving said identifying item permits a router employing said backplane board and said single board computer to operate.

26. The router of claim 25 wherein said identifying item is selected from the group consisting of a hardware serial number associated with said backplane board, a data key, and combinations thereof.

27. The router of claim 23, wherein an item selected from the group consisting of said housing, said backplane board and combinations thereof further comprises a plurality of light emitting diodes.

28. The router of claim 27 wherein said light emitting diodes are adapted to provide functions selected from the group consisting of providing a visual indication of the real time network utilization rate of said backplane board, providing a visual indication of the operation of the backplane board for the diagnosis of the operational state of said backplane board, and combinations thereof.

29. The router of claim 28 wherein during operation in a high availability mode, at least a portion of said light emitting diodes display said network utilization rate, and a portion of said light emitting diodes displays high availability heartbeats in blinks per unit of time.

30. The router of claim 23 wherein said data communications ports are horizontally aligned along the same line of axis and and are sequentially numbered such that when a plurality of ports is present, the ports are sequentially identified from one end of the aligned ports to the other wherein port 1 is the first and left-most port, the second left-most port is port 2 and the remaining ports are sequentially numbered in increasing numerical sequence proceeding to the right-most port.

31. The router of claim 23 further comprising an operating system associated with the single board computer.

32. The router of claim 31 further comprising a means for configuring said operating system.

33. The router of claim 32 wherein said operating system is configured from the group consisting of direct configuration and remote configuration over a computer networking system.

34. The router of claim 33 wherein said means are selected from the group consisting of a computer keyboard and interface, computer monitors and interface, serial data communications ports, parallel data communications ports, computer terminals, and combinations thereof.

35. The router of claim 23 further comprising a pair of redundant power supplies contained within said housing for providing electrical power to said backplane board.

36. The router of claim 35 wherein said backplane board further comprises a half bridge rectifier.

37. The router of claim 36 wherein said backplane board is adapted to receive electrical power from said pair of redundant power supplies and said half-wave bridge rectifier operates to provide fail over protection to permit said backplane board to continue to operate from electrical power supplied by only one of said power supplies should either power supply fail to provide electrical power to said backplane board.

38. The router of claim 23 further comprising a plurality of cooling fans retained within said housing;

39. The router of claim 38 wherein said cooling fans are powered by one or more power takeoffs from said backplane board, at least a portion of said power takeoffs further comprising a polyfuse.

40. The router of claim 23, said router being adapted to operate with a peripheral computer interface bus with 32-bits and 33 megahertz clock speeds.

41. The router of claim 23 further comprising an adaptive firewall protection.

42. The router of claim 41 further comprising denial of service protection.
